(19) United States
(12) Patent Application Publication
(10) Pub. No.: US 2013/0145393 A1
(43) Pub. Date: Jun. 6, 2013

(54) SPLASH SCREEN ADVERTS FOR DIGITAL TELEVISIONS

(71) Applicant: Itamar Gold-Gavriely, Sunnyvale, CA (US)

(72) Inventor: Itamar Gold-Gavriely, Sunnyvale, CA (US)

(21) Appl. No.: 13/425,439

(22) Filed: Mar. 21, 2012

Related U.S. Application Data
(60) Provisional application No. 61/566,229, filed on Dec. 2, 2011.

(51) Int. Cl. H04N 21/80

(52) U.S. Cl. 725/32

(57) ABSTRACT

An electronic device system includes: a network device; a non-volatile memory, for storing at least an image; an electronic device, including: a System-on-A-Chip; and a network connection, for downloading files containing at least the image from the network device. The electronic device further includes a display, for presenting the image when the network connection is not enabled.

### CROSS REFERENCE TO RELATED APPLICATIONS

This application is a non-provisional application of U.S. provisional application No. 61/566,229, which was filed on Dec. 2, 2011, the contents of which are included herein by reference.

### BACKGROUND

This invention relates to splash screen images, and more particularly to splash screen images that display information or advertisements previously accessed and downloaded from a network connection.

Modern electronic devices such as digital televisions require a certain time after being powered on in order to load programs and set up operating systems for normal operations. This time period is often referred to as a boot-up time. During the boot-up time, the device will usually display a picture or message on a display screen, which is known as a splash screen. This splash screen may simply be the logo of the particular device being used, or may contain information related to the state of the operating system. Some display devices such as mobile phones allow a user to select a photograph or graphic from the device's memory to be displayed during this boot-up time. This image must be preset before a next boot-up time, however, which means only information which has been previously selected by a user is presented to the user via the splash screen during a next boot-up.

As the display screen is operational during boot-up, there is an opportunity to use the limited activity period of an electronic device to provide the user with outside information pre-downloaded from a network connection.

### SUMMARY

It is therefore one of the objectives of the present disclosure to provide an electronic device system which uses a network connection to download images to a storage of an electronic device, and displays the images during a next boot-up time of the electronic device. The images maybe multi-media files, and the display capabilities of the electronic device may include interactive functions.

An electronic device system comprises: a network device; a non-volatile memory, for storing at least an image; and an electronic device, comprising: a System-on-A-Chip; and a network connection, for downloading files containing at least the image from the network device. The electronic device further comprises a display, for presenting the image when the network connection is not enabled.

An electronic device system comprises: a network device; a non-volatile memory for storing at least an image; and an electronic device, comprising: a System-on-A-Chip; and a network connection, for downloading files containing at least the image from the network device. The electronic device further comprises a display for presenting the image when the network connection is not enabled, wherein the image contains information that can be accessed according to a specific user command.

A method for displaying a downloaded image during a boot-up time or shut-down time of an electronic device comprises: utilizing a network connection of the electronic device to couple to a specific network device; when there is a file containing at least an image in the specific network device, downloading the image to a non-volatile memory of the electronic device; and displaying the image on a display of the electronic device during a next boot-up time or shut-down time of the electronic device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an electronic device system according to an exemplary embodiment.

FIG. 2 is a flowchart illustrating a method of displaying a modified splash screen to a user according to the exemplary embodiment.

FIG. 3 is a flowchart illustrating a method of accessing and downloading a modified splash screen according to the exemplary embodiment.

### DETAILED DESCRIPTION

During boot-up time of an electronic device with display capability, a stored image will be displayed on a display screen of the electronic device, which is known as a splash screen. As the display capability of the electronic device is operational from early boot-up stages after power-on, the disclosure aims to utilize this boot-up time for presenting a user with certain information in the form of splash advertisements such as multi-media images.

The following description will detail certain embodiments and means of receiving and displaying these splash advertisements or modified splash screens. It will be understood that the following examples are provided as means for best achieving the objectives of the disclosure but are not intended to be taken as limitations.

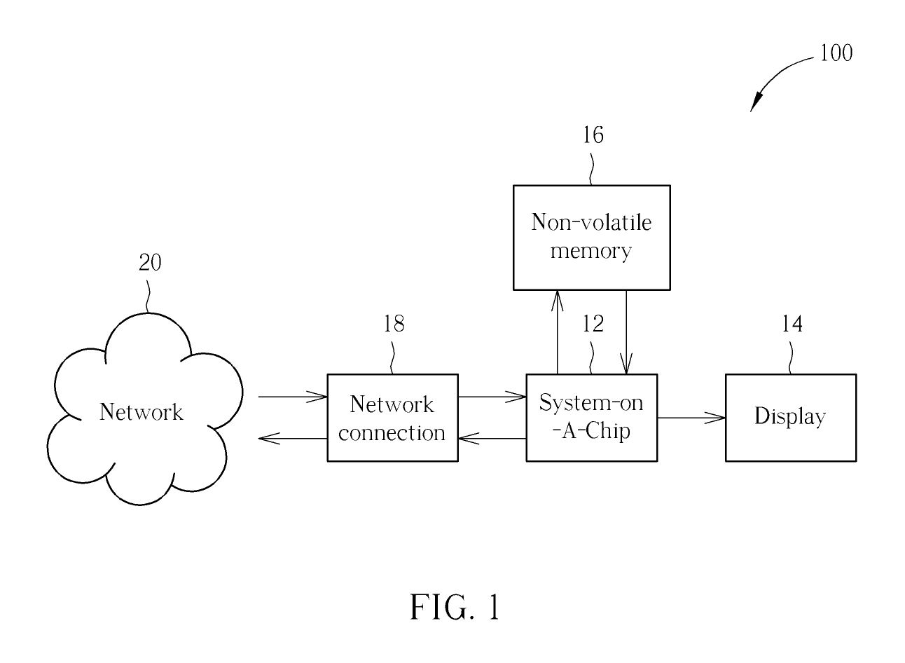

As illustrated in FIG. 1, an electronic device system 100 includes a System-on-A-Chip 12 coupled to a non-volatile memory 16 and a display 14. During standard operation of the electronic device system 100 (when the System-on-A-Chip 12 is connected to a network server 20 via a network connection 18), a file containing at least an image will be downloaded to the non-volatile memory 16 (storage) of the electronic device system 100. This image may be an advertisement, a news announcement, or public service information. The next time that the electronic device system 100 is powered on, the downloaded and stored image will be displayed on the display 14 during the boot-up time, taking the place of the standard splash screen. The non-volatile memory device 16 maybe directly coupled to the System-on-A-Chip 12, or may be a USBkey or SD card. Further, the display 14 may similarly be directly coupled to the System-on-A-Chip 12, or may be a monitor which can communicate with the System-on-A-Chip 12 via an HDMI cable or wirelessly.

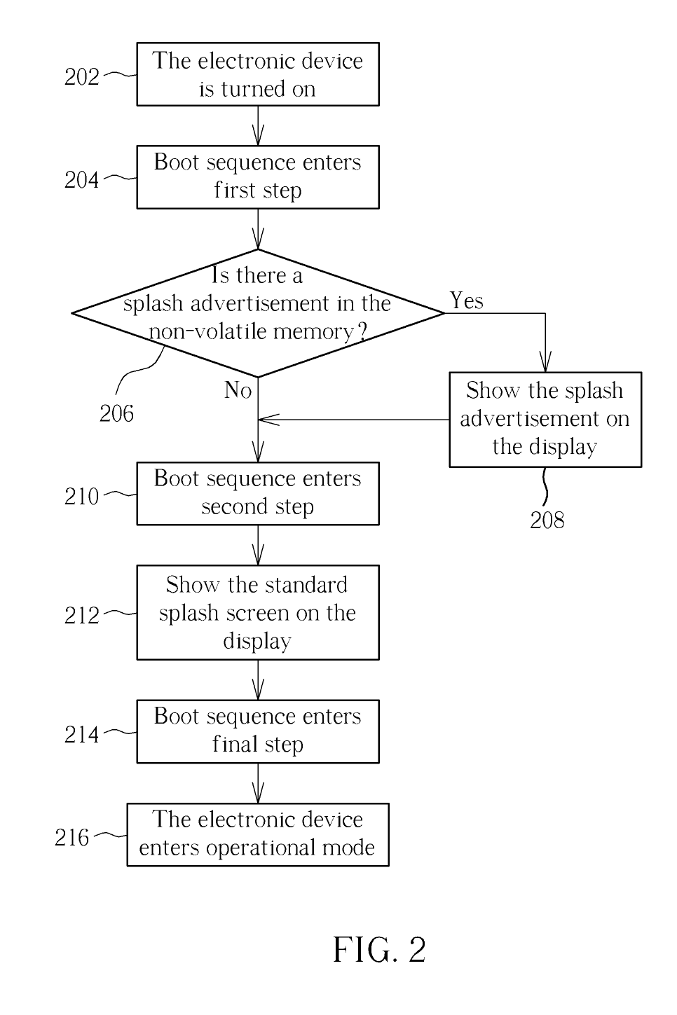

Please refer to FIG. 2, which illustrates a flowchart detailing the steps of displaying the downloaded splash advertisement during a boot-up time. Please note that, although the boot sequence is illustrated as consisting of three steps, this should not be taken as a limitation. Also, the illustrated steps may have other steps inserted in-between.

Step 202: The electronic device is turned on;

Step 204: Boot sequence enters first step;

Step 206: Is there a splash advertisement in the non-volatile memory? If yes, go to Step 208; if no, go to Step 210;

Step 208: Show the splash advertisement on the display;

Step 210: Boot sequence enters second step;

Step 212: Show the standard splash screen on the display;

Step 214: Boot sequence enters final step;

Step 216: The electronic device enters operational mode.

The image content is not limited to the above examples. Depending on the particular electronic device and its display capabilities, the image may be a multimedia image (i.e. including audio, a video image, or an A/V image). Further, the electronic device system 100 is not limited to displaying one image only. Depending on the length of the boot-up time and size of the display 14, the electronic device system 100 can display a plurality of images. Other display formats are also possible; for example, Picture in Picture or thumbnail images. Please note that the disclosure uses boot-up time as an example of when splash advertisements can be displayed, but it is also possible to display splash advertisements during a shut-down time. The main requirement for when to display the splash advertisements is that the electronic device only has limited capabilities with at least a display capability but cannot perform all normal functions—in other words, a time period wherein a user cannot operate the electronic device in a normal mode.

In one embodiment, the electronic device system 100 will only store a single ‘boot-up image’, wherein the image is replaced provided that the electronic device system 100 connects to the server or outside network (please note, in FIG. 1, the illustrated network 20 may be a server or an outside network). In another embodiment, the electronic device system 100 may download a plurality of images during connectivity time, and randomly display the downloaded and stored images during a next boot-up time, or rotate the images respectively over a next plurality of boot-up times.

It should be noted that the format of the files obtained from the network 20 may be different from the format in which the files are displayed. The 100 system has the capability to automatically convert the files when they are downloaded, so that they will directly be presented during the next boot-up time of the electronic device system 100.

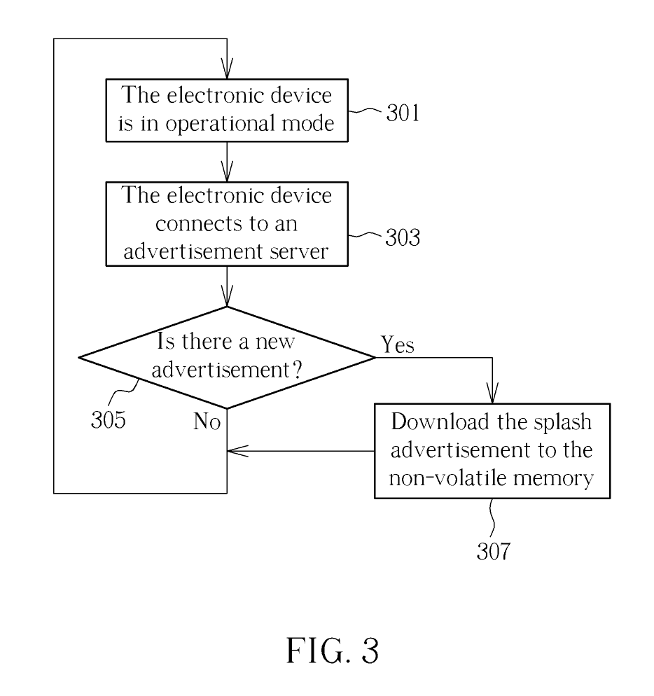

Please refer to FIG. 3, which illustrates a flowchart detailing the steps of downloading the splash advertisements. Please note that the illustrated steps may have other steps inserted in-between.

Step 301: The electronic device is in operational mode;

Step 303: The electronic device connects to an advertisement server;

Step 305: Is there a new advertisement? If yes, go to Step 307; if no, return to Step 301;

Step 307: Download the splash advertisement to the non-volatile memory.

The method of obtaining the images can also have several embodiments. In the example given above regarding public information announcements, such information may be sent out during certain time periods. For example, around the holiday season, a local government may send out “Do not drink and drive” messages, or during local or national elections, information may be sent reminding citizens when and where to vote. In the example given above regarding advertisements, businesses may buy certain time periods where they can send information to the electronic devices. The type of splash advertisement which is downloaded to the electronic device system 100 will depend on the advertisement server to which the electronic device system 100 is connected.

The sources of information can also be tailored according to a user's Internet habits, or by setting individual preferences. For example, if a user often visits a gaming website, game manufacturers may send information regarding new video games to the user's electronic device. Where a user requires new information that is constantly updated, the user may elect to adjust settings such that they only receive information regarding, for example, new automobiles or travel deals.

As some information presented via the splash advertisements maybe of particular interest to the user, the system 100 also offers the option of saving the splash advertisement to another memory, so it will not be replaced by a new splash advertisement when the electronic device system 100 again connects to the server or network 20. It is also possible that the image remains in the original memory location (the non-volatile memory 16), but the user elects to display the image again during a next boot-up time, or the user elects to increase the memory capacity so that the image is saved alongside a new splash advertisement. In some embodiments, images may be buffered in order, and the earliest images replaced with new splash advertisements when buffer capacity is reached.

As will be appreciated by one skilled in the art, there are many options for viewing the saved splash advertisement again, such as: opting to display again (i.e. during a next boot-up time); saving and then retrieving from another memory location; opting to show at a later time determined by the user; ‘freezing’ the image screen; or providing a ‘go back’ function wherein a plurality of splash advertisements are saved, and can be accessed either one by one, or via a look-up table etc. It is also possible to move the splash advertisement to another device peripheral to the main electronic device system 100.

To better determine which advertisements or information to send to a user, the system 100 can also include a reporting facility, wherein when a splash advertisement is saved or accessed again by a user, the details will be recorded and feedback sent to the source. In the example where a user elects to save the splash advertisement to another memory location, the system 100 will record the save operation, and provide the feedback to the source. The system 100 can then further record how often the saved advertisement is accessed. This allows the system 100 to tailor information to the user in future.

In another embodiment, the images displayed to the user may be interactive. Many electronic devices include touch screens for directly accessing information displayed thereon. In these cases, the information provided may be composed of a series of images, wherein a first displayed image must be clicked or tapped on to access a next image, and so on. In another example, an image may be made up of many thumbnails, each of which can be clicked on to enlarge. The images could be presented in a series of questions, where the answer that is given to a first question shown in a first image dictates a next image to be displayed.

Boot-up time (or shut-down time) is a time period where the electronic device system 100 does not have network capability. The interactive image may contain certain material requiring network capability such as website addresses, options to download further information etc. In such cases, the image will continue to be displayed after the boot-up time is over, so that the electronic device system 100 can utilize the network connection 18 to access this information.

One skilled in the art will appreciate that various modifications can be made to the above examples without departing from the spirit of the disclosure. To summarize, the electronic device system 100 as claimed utilizes a network connection 18 to couple to a network 20 for downloading files containing at least an image and saving them to a non-volatile memory 16, wherein the image may be a multi-media image, and then presents the image via a display 14 during a next boot-up or shut-down time of the electronic device system 100. In some embodiments, the display 14 and/or the presented image are interactive. In some embodiments, the user can save the image to another storage or device peripheral to the electronic device. In some embodiments, the electronic device system 100 can use user actions regarding the image to report back to the image source. In other embodiments, the type of files to be downloaded can be determined according to user settings, user profile, location of the electronic device, user history, or electronic device type.

By utilizing splash screens to display images which are downloaded during a network connection time of an electronic device, the inactivity time of the electronic device can be utilized to provide users with new and updated information even when the network capability of the electronic device is not operational.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device system, comprising:
a network device;
a non-volatile memory, for storing at least an image;
an electronic device, comprising:
a System-on-A-Chip; and
a network connection, for downloading files containing at least the image from the network device; and
a display, for presenting the image when the network connection is not enabled.

2. The electronic device system of claim 1, wherein the network device is a network server.

3. The electronic device system of claim 1, wherein the electronic device automatically converts the downloaded files into a format suitable for the display screen.

4. The electronic device system of claim 1, wherein the image is presented during a boot-up or shut-down time of the electronic device.

5. The electronic device system of claim 4, wherein the boot-up time is defined as the time period between the electronic device being powered on and the electronic device being ready to operate in a standard mode; and the shut-down time is defined as the time period between a user command to shut down the electronic device and the electronic device is powered off.

6. The electronic device system of claim 1, wherein the file is an audio file, a video file, an audio-video file, or a multi-media file.

7. The electronic device system of claim 1, wherein the non-volatile memory stores a plurality of images; and the plurality of images are presented during the boot-up time or the shut-down time.

8. The electronic device system of claim 7, wherein the plurality of images are presented as a Picture in Picture display.

9. The electronic device system of claim 7, wherein the plurality of images are presented as thumbnail images.

10. The electronic device system of claim 1, wherein the network device downloads files to the non-volatile memory via the network connection as soon as the network connection is enabled, or according to a user setting, or according to a periodical scheme.

11. The electronic device system of claim 1, wherein the downloaded image is saved into a storage located separately from the non-volatile memory in response to a user command.

12. The electronic device system of claim 1, wherein downloaded images are automatically buffered, and the earliest downloaded image will be deleted when buffer capacity is reached.

13. The electronic device system of claim 1, wherein the electronic device determines which files to download to the non-volatile memory according to network connection parameters including user settings, a location of the electronic device, a user profile, previous user activity, or an identification of the electronic device.

14. The electronic device system of claim 13, wherein the System-on-A-Chip periodically updates the network connection parameters for determining which files to download to the non-volatile storage.

15. The electronic device system of claim 1, further comprising:
a peripheral device, comprising at least a display, for presenting the image.

16. An electronic device system, comprising:
a network device;
a non-volatile memory for storing at least an image;
an electronic device, comprising:
a System-on-A-Chip; and
a network connection, for downloading files containing at least the image from the network device; and
a display for presenting the image when the network connection is not enabled;
wherein the image contains information that can be accessed according to a specific user command.

17. The electronic device system of claim 16, wherein the network device is a network server.

18. The electronic device system of claim 16, wherein the electronic device automatically converts the downloaded files into a format suitable for the display.

19. The electronic device system of claim 16, wherein the image is presented during a boot-up or shut-down time of the electronic device.

20. The electronic device system of claim 19, wherein the boot-up time is defined as the time period between the electronic device being powered on and the electronic device being ready to operate in a standard mode; and the shut-down time is defined as the time period between a user command to shut down the electronic device and the electronic device powering off.

21. The electronic device system of claim 16, wherein the file is an audio file, a video file, an audio-video file, or a multi-media file, and the presented image is a telescopic image, contains Internet access links, or can be manipulated via the specific user command.

22. The electronic device system of claim 16, wherein the non-volatile memory stores a plurality of images, and the plurality of images are presented when the network connection is not enabled.

23. The electronic device system of claim 16, wherein the network device can download files to the non-volatile memory via the network connection as soon as the network connection is enabled, according to a user setting, or according to a periodical scheme.

24. The electronic device system of claim 16, wherein the downloaded image can be saved into a storage located separately from the non-volatile memory in response to a user command.

25. The electronic device system of claim 16, wherein downloaded images are automatically buffered, and the earliest downloaded image will be deleted when buffer capacity is reached.

26. The electronic device system of claim 16, wherein the electronic device determines which files to download to the non-volatile memory according to network connection parameters including user settings, a location of the electronic device, a user profile, previous user activity, or an identification of the electronic device.

27. The electronic device system of claim 26, wherein the System-on-A-Chip periodically updates the network connection parameters for determining which files to download to the non-volatile memory.

28. The electronic device system of claim 16, wherein the information is network content and the specific user command causes the System-on-A-Chip to couple to the network device via the network connection for displaying the network content.

29. The electronic device system of claim 16, wherein the information is a plurality of images stored in the non-volatile memory and each specific user command causes the display to display an image of the plurality of images.

30. The electronic device system of claim 16, wherein the display is an interactive display and the specific user command is a touch on the interactive display.

31. The electronic device system of claim 16, wherein the specific user command is a remote command.

32. A method for displaying a downloaded image when a network connection of an electronic device is not enabled, the method comprising:
utilizing a network connection of the electronic device to couple to a specific network device;
when there is a file containing at least an image in the specific network device, downloading the image to a non-volatile memory of the electronic device; and
displaying the image on a display of the electronic device during a next boot-up time or shut-down time of the electronic device.

33. The method of claim 32, wherein the boot-up time is defined as the time period between the electronic device being powered on and the electronic device being ready to operate in a standard mode; and the shut-down time is defined as the time period between a user command to shut down the electronic device and the electronic device powering off.

34. The method of claim 32, wherein the file is an audio file, a video file, an audio-video file, or a multi-media file, and the presented image is a telescopic image, contains Internet access links, or can be manipulated via a user command.

35. The method of claim 32, further comprising:
deleting the image from the non-volatile memory after the image has been displayed.

36. The method of claim 32, wherein the step of downloading the image to a non-volatile memory of the electronic device comprises:
when the non-volatile memory already contains an image, replacing the original image with the downloaded image.

37. The method of claim 32, wherein the step of downloading the image to a non-volatile memory of the electronic device comprises:
when the non-volatile memory already contains an image, downloading the image and storing it alongside the original image.

38. The method of claim 37, further comprising:
each time an image is downloaded, retaining all images in the non-volatile memory until the non-volatile memory reaches capacity.

39. The method of claim 32, wherein the step of utilizing a network connection of the electronic device to couple to a specific network server comprises:
coupling to the network server at a specified time.

40. The method of claim 32, wherein the step of utilizing a network connection of the electronic device to couple to a specific network server comprises:
coupling to the specific network server according to user settings.

41. The method of claim 32, wherein the step of utilizing a network connection of the electronic device to couple to a specific network server comprises:
coupling to the specific network server according to a user history.

42. The method of claim 32, wherein the step of utilizing a network connection of the electronic device to couple to a specific network server comprises:
coupling to the specific network server according to an outside server.
